(19) United States
(12) Patent Application Publication
(10) Pub. No.: US 2004/0191615 A1
(43) Pub. Date: Sep. 30, 2004

(54) Battery cover

(76) Inventors: Scott Eric Johnson, Cordova, TN (US); Anthony C. Edwards, Bartlett, TN (US); John W. Reinagel JR., Cordova, TN (US)

Correspondence Address: SHAW PITTMAN, IP GROUP, 1650 TYSONS BOULEVARD, SUITE 1300, MCLEAN, VA, 22102, US

(21) Appl. No.: 10/400,408

(22) Filed: Mar. 28, 2003

(51) Int. Cl. H01M 2/02; H01M 2/12

(52) U.S. Cl. 429/121; 429/175; 429/82; 429/87

(57) ABSTRACT

A device for covering a battery is disclosed having terminal connections projecting from an upper surface of the battery. The cover comprises an outer periphery configured to mate with the upper surface of the battery, a top surface facing away from the terminal connections, and a bottom surface facing toward the terminal projections. The device may also define at least one terminal opening configured to allow connection of a battery cable to at least one of the terminal connections when the device is in a mating position with respect to the battery.

### BACKGROUND

1. Field of the Invention

The present invention relates generally to battery covers, and more particularly to battery covers used with vehicle batteries.

2. Background of the Invention

A car battery is a rechargeable electrochemical device that stores chemical energy and releases it as electrical energy upon demand. When a car battery is connected to an external circuit, chemical energy is converted to electrical energy and current flows through the circuit.

Batteries are typically made of five basic components: a plastic container typically made of polypropylene, positive and negative internal plates typically made of lead, plate separators typically made of a porous synthetic material, an electrolyte such as a dilute solution of sulfuric acid and water, and lead terminals which form the connection points between the battery and the external circuit it powers.

There are currently two primary types of vehicle batteries in wide spread use: the 6 volt battery used in motorcycles and the 12 volt battery used in automobiles, although other voltages will soon be in use. A standard 12-volt battery is made up of six cells connected in series. The cells are filled with an electrolyte and produce approximately two volts each. The cells are individually separated with thin sheets of electrically insulating plate separators that are used as spacers to keep them apart.

Car batteries come in different sizes, with their terminals in different locations. FIGS. 1A-1E depict five types of batteries according to the location of the terminals: SAE post terminal 112, “L” terminal 114, combination SAE and stud terminal 116, stud terminal 118, and combination SAE post and GM side terminal 120.

A car battery can cause serious injuries. In addition to being an electrical shock hazard, the sulfuric acid electrolyte in a battery is a highly corrosive acid that can cause serious injuries. Sulfuric acid electrolyte also produces highly flammable gases, such as hydrogen. If a tool touches both battery posts or a battery post and metal parts of the vehicle, a short circuit might result, which, in turn, could cause a dangerous battery explosion. Further, when an electrolyte in a battery is mixed with even small quantities of salt water, a deadly chorine gas is produced.

### SUMMARY OF THE INVENTION

The present invention is directed to a battery cover, which, among other things, helps to avoid accidental short circuits and to vent noxious gases. The cover comprises an outer periphery configured to mate with the upper surface of the battery, a top surface facing away from the terminal connections, and a bottom surface facing toward the terminal projections. The device may also define at least one terminal opening configured to allow connection of a battery cable to at least one of the terminal connections when the device is in a mating position with respect to the battery.

According to another aspect of the invention, a battery cover comprises an outer periphery configured to mate with the upper surface of the battery, a top surface facing away from the terminal connections, and a bottom surface facing toward the terminal projections. The cover may also define at least one terminal opening configured to allow connection of a battery cable to at least one of the terminal connections when the device is in a mating position with respect to the battery.

### BRIEF DESCRIPTION OF THE DRAWINGS

FIGS. 1A-1E are schematic diagrams illustrating different types of batteries.

FIG. 2 is an orthogonal schematic diagram of a battery cover.

FIG. 3 is a plan view schematic diagram of the top of the cover of FIG. 2.

FIG. 4 is a plan view schematic diagram of the underside of the cover of FIG. 2.

FIG. 5 is an orthogonal schematic view of the battery cover of FIG. 2 fitted on a battery having top mounted post terminals.

FIG. 6 is an orthogonal schematic view of an alternative embodiment of the battery cover with a battery having side terminals.

FIG. 7 is an orthogonal view of an alternative embodiment of a battery cover with a battery having both side and top terminals.

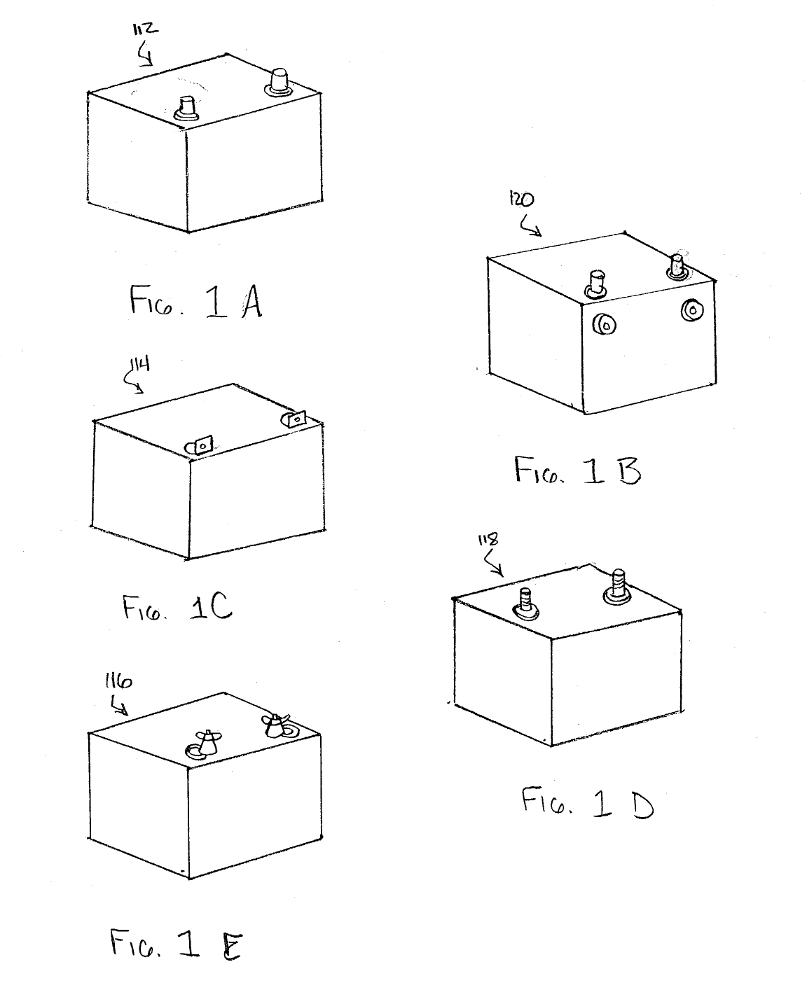

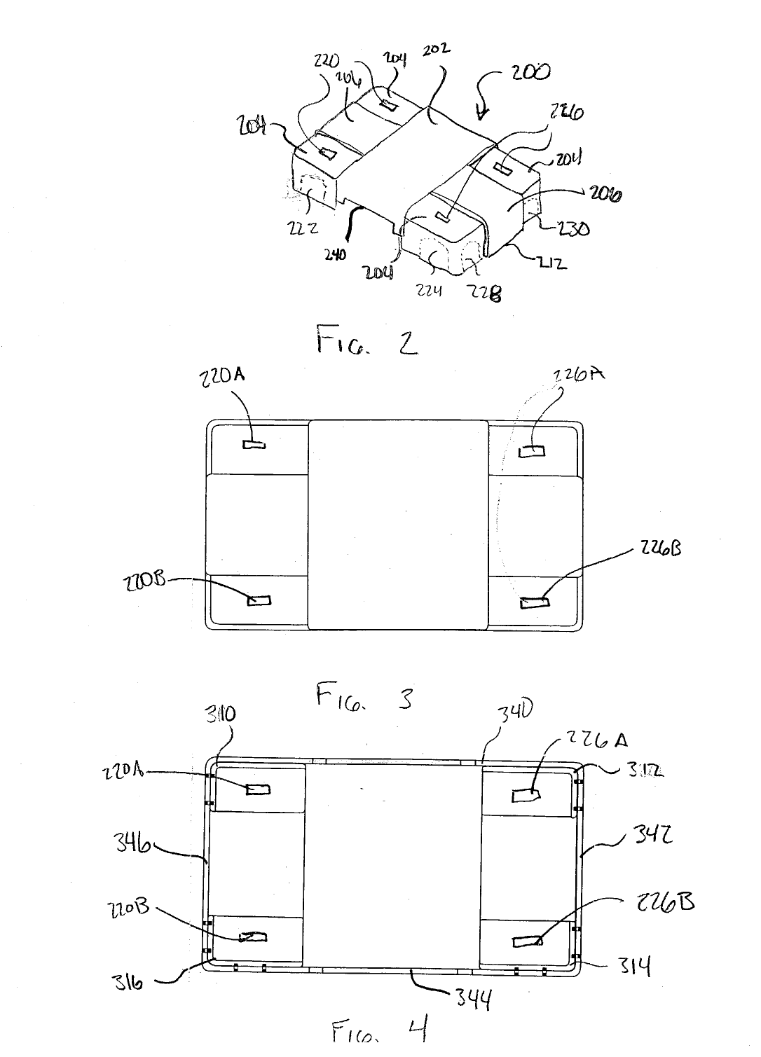

### DETAILED DESCRIPTION OF THE INVENTION

Reference will now be made in detail to various exemplary embodiments of the present invention, examples of which are illustrated in the accompanying drawings.

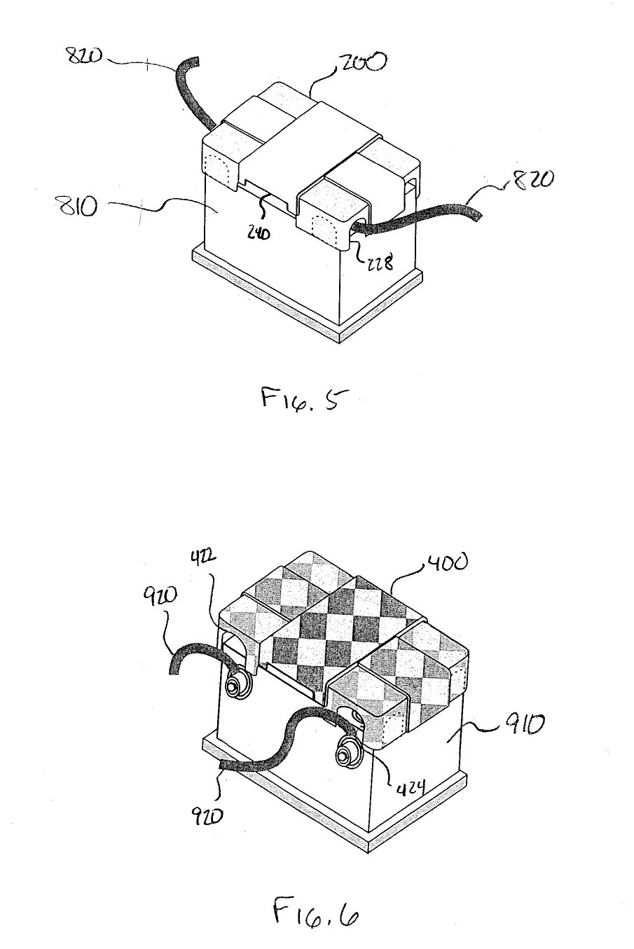

FIG. 2 shows a battery cover 200 in accordance with the present invention. As shown, battery cover 200 has a substantially rectangular shape with an outer periphery 212. Although depicted as being substantially perpendicular to the upper surface of battery cover 200, edges of battery cover 200 may also be slightly tapered or otherwise configured so that, for example, various battery sizes may be usable with a single cover. Cover 200 also includes apertures for venting and receiving cable that connects the battery to the circuits of the automobile when the battery cover is placed on the battery. Preferably, battery cover 200 includes multiple cable receiving apertures to accommodate different locations of terminals. The cable receiving apertures can assume any desired shape. In an exemplary embodiment shown in FIG. 2, battery cover 200 includes cable receiving apertures 222, 224, 228, and 230.

Battery cover 200 further comprises a plurality of planar surfaces 202, 204, and 206. Planar surfaces 202, 204, and 206 are all substantially parallel to one another and lie in different planes spaced apart from one another. Such a configuration adds strength to cover 200 and may also provide a decorative aspect. Although three distinct planar levels are shown in FIG. 2, more or fewer planar surfaces could be used as desired. In addition, multiple layers such as this may assist in directing toxic gases toward the various ventilation holes.

Each of surfaces 202, 204, and 206 may also be constructed of differing thick nesses. For example, surface 202 may be thicker than surface 206, which may in turn be thicker than surface 204. With such a configuration, although vent openings 220 and 226 are at the lowest plane with respect to the upper surface of cover 200, from an underside, these openings may be at a higher plane than the undersides of surfaces 202 and 206. In this fashion, as described above, gases that are lighter than air would be inclined to move toward the topmost area, which would be the underside of surfaces 204 and thus be directed toward openings 220 and 226.

In addition to top vent openings, battery cover 200 may also include side vent openings 240. Vent openings 240 are generally rectangular in shape and are located along one or more of the plurality of sides. Vent openings 240 allow for gases that may be heavier than air also to flow away from the battery. Gases may also vent from cable apertures 222, 224, 228, and 230.

FIG. 4 is an underside view of the battery cover of FIG. 2. Comers 310, 312, 314, and 316 of battery cover 200 are perpendicular to the upper surface of cover 200, but may also be tapered so as to allow the battery cover to be able to fit onto different size batteries. Comers 310, 312, 314, and 316 and sides 340, 342, 344, and 346 of battery cover 200 may also be slightly curved to provide more universal fit to a range of vehicle batteries.

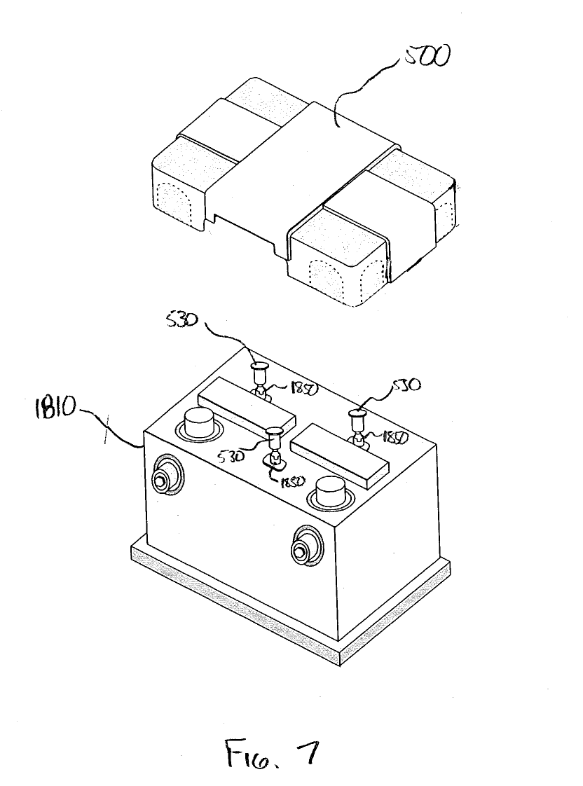

FIG. 5 shows battery cover 200 placed on a battery 810. As shown, battery cover 200 provides the coverage for the top portion of battery 810. As shown, battery cables 820 pass through apertures 228 and connect to terminals (not shown) located on an upper surface of battery 810. By covering the terminals of battery 810, battery cover 200 may prevent an electric shock hazard. Also, battery cover 200 may prevent a tool from accidentally touching both battery posts or a battery post and metal parts of the vehicle, thus reducing the possibility of a battery explosion caused by an accidental short circuit. Furthermore, battery cover 200 may prevent the foreign substances, such as salt water, from entering a battery and being mixed with battery electrolyte.

FIG. 6 shows a battery cover 400 for use with a side terminal battery 910.

Battery cover 400 covers a top of the side terminal battery and outer periphery 212 (shown in FIG. 2) of the battery cover provides a roof over the terminals of the side terminal battery. When battery cover 400 is in place on battery 910, battery cables 920 may be connected to the side terminals and are provided the necessary clearance by apertures 422 and 424. Battery cover 400 also includes a decorative top surface which may be desirable for users who wish to customize their vehicles.

FIG. 7 shows a battery cover 500, which is substantially the same as battery cover 200. In addition to the features of battery cover 200, battery cover 500 includes a plurality of spacer members 530 which may assist in mounting cover 500 to battery 1810. Spacer members 530 are configured to mate with posts 1850 located on an upper surface of battery 500. Spacer members 530 may, for example, affix to posts 1850 via a friction or interference fit. Spacers 530 additionally may be reversibly affixed to battery cover 500, for example, by an adhesive s. Posts 1850 may be formed as part of the top surface of the battery or they may alternatively be affixed to the cover, for example by double sided tape. Other known methods may be used to affix spacers 530 to battery cover 500 or to affix posts 1850 to the battery. Additionally, spacers 530 may be formed integrally with battery cover 500.

The foregoing disclosure of the exemplary embodiments of the present invention has been presented for purposes of illustration and description. It is not intended to be exhaustive or to limit the invention to the precise forms disclosed. For example, the present invention could be used with car batteries, truck batteries, van batteries, and boat batteries all of any voltage as may be used in the particular application. Many variations and modifications of the embodiments described herein will be apparent to one of ordinary skill in the art in light of the above disclosure.

What is claimed is:

1. A device for covering a battery having terminal connections projecting from an upper surface of the battery, comprising:
an outer periphery configured to mate with the upper surface of the battery;
a top surface facing away from the terminal connections; and
a bottom surface facing toward the terminal projections,
the device defining at least one terminal opening configured to allow connection of a battery cable to at least one of the terminal connections when the device is in a mating position with respect to the battery.

2. The device of claim 1, further defining at least one vent opening to allow venting of gases away from the terminal connections.

3. The device of claim 1, further comprising a decorative design on the top surface of the device.

4. The device of claim 1, wherein the top surface comprises at least two surface elevations, each elevation being spaced a different distance from the upper surface of the battery.

5. The device of claim 1, further comprising at least one spacer member.

6. The device of claim 5, wherein the at least one spacer member is reversibly affixed to the device.

7. The device of claim 6 wherein the at least one spacer member is affixed by an adhesive.

8. The device of claim 5, wherein the at least one spacer member is configured to mate with a post projecting from the upper surface of the battery.

9. The device of claim 8, wherein the spacer member is configured to mate with the post via one of a friction fit and an interference fit.

10. The device of claim 1, wherein the outer periphery is configured to accommodate different sized batteries.

11. A vehicle battery comprising:
(a) lead-acid battery having an upper surface and at least two terminals;
(b) a cover for the lead acid battery comprising:
an outer periphery configured to mate with the upper surface of the lead acid battery;
a top surface facing away from the terminal connections; and
a bottom surface facing toward the at least two terminals;
the cover defining at least one terminal opening configured to allow connection of a battery cable to at least one of the terminals when the cover is in a mating position with respect to the lead acid battery.

12. A device for covering a battery having at least two terminal connections projecting from an upper surface of the battery, comprising:
a substantially planar portion;
a plurality of sides extending substantially perpendicular from said substantially planar portion;
at least one battery cable opening defined by one of said plurality of sides configured to allow connection of a battery cable to at least one of the terminal connections; and
at least one vent opening defined by at least one of said plurality of sides.

13. The device of claim 12, wherein the substantially planar portion comprises a plurality of planar surfaces, wherein at least two of the plurality of planar surfaces define separate planes spaced a distance from each other.

14. The device of claim 12, wherein the plurality of sides comprises four sides.

15. The device of claim 14, wherein at least three of the four sides each define two battery cable openings.

16. The device of claim 12, wherein the plurality of sides define at least four vent openings.

17. The device of claim 16, wherein each of said vent openings has a substantially rectangular shape.

18. The device of claim 13, wherein the at least one vent opening is defined by at least one of said plurality of sides.

19. A device for covering a battery having at least two terminal connections projecting from an upper surface of the battery, comprising:
a top portion;
a plurality of sides extending substantially perpendicular from said top portion;
at least one battery cable opening defined by one of said plurality of sides configured to allow connection of a battery cable to at least one of the terminal connections; and
at least one vent opening defined by at least one of said plurality of sides, the top portion comprising a plurality of planar surfaces, wherein at least two of the plurality of planar surfaces define separate planes spaced a distance from each other.
